(19) United States
(12) Patent Application Publication
(10) Pub. No.: US 2026/0268646 A1
(43) Pub. Date: Sep. 10, 2026

(54) MACHINE-LEARNING BASED METHOD FOR ASSIGNING PARTICIPANTS TO BREAKOUT ROOMS

(71) Applicants: Constructor Technology AG, Schaffhausen (CH); Constructor Education and Research Genossenschaft, Schaffhausen (CH)

(72) Inventors: Svetlana DERGACHEVA, Sofia (BG); Nikita ZHEREBTSOV, Sofia (BG); Alexander TORMASOV, Busingen am Hochrhein (DE); Laurent DEDENIS, Geneve (CH); Stanislav PROTASOV, Singapore (SG); Serg BELL, Singapore (SG); Nikolay DOBROVOLSKIY, Alanya (TR)

(21) Appl. No.: 19/074,858

(22) Filed: Mar. 10, 2025

(51) Int. Cl. G06V 10/778; G06V 10/764; G06V 20/40; G06V 40/20; G09B 5/02

(52) U.S. Cl. CPC G06V 10/7788; G06V 10/764; G06V 20/41; G06V 40/20; G09B 5/02

(57) ABSTRACT

Disclosed herein are systems and methods for machine-learning (ML)-based grouping of participants for an activity. The method also includes identifying a plurality of participants to perform an activity; obtaining a list of goals for the activity; classifying the participants into different roles using a prepared classification machine learning model (MLM) configured to classify and group the plurality of participants into the different roles involved in the activity based at least in part on a classification criterion and the list of goals for the activity; generating tasks for the activity using a task generation MLM configured to determine tasks for the participants involved in the activity based on the list of goals for the activity; and assigning, using an assignment engine, the plurality of participant into a plurality of groups based at least in part on the classification of the participants and the generated tasks.

### FIELD OF TECHNOLOGY

The present disclosure relates to the field of machine learning, and, more specifically, to systems and methods for machine-learning based methods for classifying participants into roles for performing a task and assigning participants into groups for performing a task based on the classification.

### BACKGROUND

Breakout rooms are a versatile tool used to facilitate group activities in educational, corporate, and social settings. By dividing participants into smaller groups, breakout rooms create an intimate and focused environment that encourages active engagement, collaboration, and meaningful discussions. This approach is particularly effective for activities that require teamwork, as it allows participants to interact more freely and share diverse perspectives. Grouping participants thoughtfully—based on factors such as expertise, interests, or skill—can enhance the effectiveness of the activity, ensuring a balanced and dynamic interaction within each room. Breakout rooms also provide an opportunity for participants to build connections and work collectively toward a common goal, contributing to a richer overall experience.

However, assigning participants into breakout rooms for group activities can be a challenging task, as it requires balancing various factors to create effective and diverse groups. Factors such as skill levels, personalities, relationships, and the specific goals of the activity must be carefully considered to ensure productive interactions. Additionally, logistical constraints like time limitations, the number of participants, and available facilitators can add complexity to the process. Striking the right balance between diversity and compatibility within each group is particularly difficult, as mismatched group dynamics can hinder collaboration and diminish the overall effectiveness of the activity. These challenges highlight the importance of thoughtful planning and, when possible, flexibility to adjust group compositions dynamically.

### SUMMARY

To address the shortcomings of manually or randomly assigning participants into groups for breakout rooms, the present disclosure introduces significant technical benefits in organizing and facilitating group activities by utilizing machine learning models (MLMs). Specifically, the present disclosure describes training MLMs to classify participants and generate tasks based on goals of a group activity to organize the participants into breakout rooms. Some of the technical improvements include ensuring precise and optimized group dynamics tailored to the goals of the shared task by employing a classification MLM to classify participants into different roles and group the participants into different roles involved in an activity. This eliminates inconsistencies and inefficiencies associated with manual or random methods.

In addition, the task generation MLM creates customized tasks aligned with activity goals, enabling dynamic role and task allocation that matches individual capabilities and maximizes group efficiency. The system's automation enhances scalability and efficiency, allowing it to handle large numbers of participants with minimal manual intervention, making it ideal for diverse settings like education, corporate training, or large-scale events. Personalization is another key benefit, as machine learning enables dynamic adjustments to groups and roles, fostering collaboration and compatibility while accommodating diverse needs. Furthermore, the use of data-driven decision-making reduces subjective bias, ensuring fairer and more balanced group formations while also providing actionable insights for refining future groupings. These technical improvements collectively streamline the process of organizing group activities, creating a more efficient, equitable, and productive experience for participants.

In one exemplary aspect, a method for machine-learning (ML)-based grouping of participants for an activity is disclosed. The method includes: identifying a plurality of participants to perform an activity; obtaining a list of goals for the activity; classifying the participants into different roles using a prepared classification MLM configured to classify and group the plurality of participants into the different roles involved in the activity based at least in part on a classification criterion and the list of goals for the activity; generating tasks for the activity using a task generation MLM configured to determine tasks for the participants involved in the activity based on the list of goals for the activity; and assigning, using an assignment engine, the plurality of participant into a plurality of groups based at least in part on the classification of the participants and the generated tasks.

In some aspects, the techniques described herein relate to a method further including: identifying the plurality of participants to organize into groups after a presentation; obtaining, for each participant during the presentation, a plurality of video streams capturing each respective participant, a plurality of audio streams for each respective participant, and a plurality of capture streams capturing an interaction of each participant with a respective computing device; evaluating an engagement of at least one participant during the presentation using a prepared engagement MLM configured to generate an individual engagement score for the at least one participant based on the plurality of video streams, the plurality of audio streams, and the plurality of capture streams; and classifying the participants into different roles using the prepared classification MLM configured to classify and group the plurality of participants into the different roles involved in the activity based at least in part on the classification criterion, the list of goals for the activity, and individual engagement scores.

In some aspects, the techniques described herein relate to a method further including: obtaining learning management system data (LMS) data for at least one participant, wherein the LMS data corresponds to at least one of an overall performance for participants, interests, parallel courses, career track, learning preference, social circle, or skill; and classifying the participants into different roles using the prepared classification MLM configured to classify and group the plurality of participants into the different roles involved in the activity based at least in part on the classification criterion, the list of goals for the activity, and the LMS data.

In some aspects, the techniques described herein relate to a method further including obtaining feedback corresponding to the grouping of the participants into the different roles; and training the prepared classification MLM based on the obtained feedback.

In some aspects, the techniques described herein relate to a method further including obtaining answer from a self-assessment survey for each participant; and classifying the participants into different roles using the prepared classification MLM configured to classify and group the plurality of participants into the different roles involved in the activity based at least in part on the classification criterion, the list of goals for the activity, and the answer from the self-assessment survey.

In some aspects, the techniques described herein relate to a method further including obtaining feedback corresponding to the classification of the participants into the different roles; and training the prepared classification MLM based on the obtained feedback.

In some aspects, the techniques described herein relate to a method further including obtaining the list of goals for the activity using a natural language processing (NLP) MLM.

In some aspects, the techniques described herein relate to a method further including preparing the classification MLM by: (1) providing, to the classification MLM, a classification training dataset comprising at least one of: (a) participant-specific data labeled and annotated with at least demographics, skills and expertise, experience, behavioral traits, or historical role data, (b) group activity context data labeled and annotated with at least activity type, goals, or constraints, (c) role data comprising at least role categories or role criteria, (d) interaction and communication data labeled and annotated with collaboration patterns, communication metrics, or team dynamics, (e) ground truth labels for the participant-specific data, the group activity context data, the role data, or the interaction and communication data to serve as a target output for the classification MLM, or (f) feedback from a user, and (2) preparing the classification MLM using the provided classification training dataset.

In some aspects, the techniques described herein relate to a method further including preparing the task generation MLM by: (1) providing, to the task generation MLM, a task generation training dataset comprising at least one of: (a) activity goal data labeled and annotated with goal descriptions or goal attributes, (b) task data labeled and annotated with task descriptions, task attributes, task roles, or outcome metrics, (c) participation data labeled and annotated with attributes, availability, past task performance, or role history, or (d) ground truth labels for the activity goal data, the task data, or the participation data to serve as a target output for the classification MLM; and (2) preparing the task generation MLM using the provided task generation training dataset.

In some aspects, the techniques described herein relate to a method further including preparing the engagement MLM by: (1) providing, to the engagement MLM, an engagement training dataset comprising at least one of: (a) individual video streams of participants labeled and annotated with facial expressions, gaze direction, body posture, or head movement to capture visual engagement cues, (b) corresponding audio streams labeled and annotated with speech activity, tone analysis, interruptions and pauses, or emotion detection to analyze participation through voice contribution and tone of speech, (c) capture streams of the participants comprising at least one of at least keyboard input, mouse movements, or screen interactions, wherein the capture streams are labeled and annotated with active engagement, passive behavior, or multitasking to measure interaction of the participants with a respective computing device, (d) an event list comprises at least one of interaction events, participation events, attention-related events, engagement-related events, time-based events, or behavioral and biometric events annotated with engagement levels, activity frequency, or contribution quality to capture session-specific events that indicate participant engagement, and (e) ground truth labels for the individual video streams, the corresponding audio streams, the capture streams, or the event list to serve as a target output for the engagement MLM; and (2) preparing the engagement MLM using the provided engagement training dataset.

In some aspects, the techniques described herein relate to a method further including generating and displaying, on a display, a list of group assignments for the plurality of participants.

In some aspects, the techniques described herein relate to a method further including assigning the plurality of participants to virtual breakout rooms.

According to one aspect of the disclosure, a system is provided for machine-learning (ML)-based grouping of participants for an activity, the system including: at least one memory; and at least one hardware processor coupled with the at least one memory and configured, individually or in combination, to: identify a plurality of participants to perform an activity; obtain a list of goals for the activity; classify the participants into different roles using a prepared classification MLM configured to classify and group the plurality of participants into the different roles involved in the activity based at least in part on a classification criterion and the list of goals for the activity; generate tasks for the activity using a task generation MLM configured to determine tasks for the participants involved in the activity based on the list of goals for the activity; and assign, using an assignment engine, the plurality of participant into a plurality of groups based at least in part on the classification of the participants and the generated tasks. In one exemplary aspect, a non-transitory computer-readable medium is provided storing a set of instructions thereon for ML-based grouping of participants for an activity, the system, including instructions for: identifying a plurality of participants to perform an activity; obtaining a list of goals for the activity; classifying the participants into different roles using a prepared classification MLM configured to classify and group the plurality of participants into the different roles involved in the activity based at least in part on a classification criterion and the list of goals for the activity; generating tasks for the activity using a task generation MLM configured to determine tasks for the participants involved in the activity based on the list of goals for the activity; and assigning, using an assignment engine, the plurality of participant into a plurality of groups based at least in part on the classification of the participants and the generated tasks.

The above simplified summary of example aspects serves to provide a basic understanding of the present disclosure. This summary is not an extensive overview of all contemplated aspects and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for classifying and organizing participants into groups for completing a shared activity according to aspects of the present disclosure.

FIG. 2 is a block diagram illustrating a system for preparing machine learning models to classify and organize participants into groups to perform a shared activity and generate tasks for the shared activity according to aspects of the present disclosure.

FIG. 3 is an example flowchart for organizing participants into groups according to aspects of the present disclosure.

FIG. 4 is an example method for a ML-based grouping of participants into breakout rooms for completing a shared activity according to an aspect of the present disclosure.

FIG. 5 presents an example of a general-purpose computer system on which aspects of the present disclosure can be implemented.

Like reference numbers and designations in the various drawings indicate like elements.

### DETAILED DESCRIPTION

Exemplary aspects are described herein in the context of a system, method, and computer program product for a ML based method of classifying participants into different roles and assigning participants into breakout rooms for performing a shared activity. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The use of ML methods to classify and group participants into different roles for an activity and then assign participants to breakout rooms introduces an innovative approach to facilitating collaborative activities. Traditional methods of classifying and grouping often rely on random assignment or manual processes, which may overlook the nuanced factors that influence group dynamics and productivity. By integrating machine learning, the process begins with determining a clear goal for the shared activity and generating a task list tailored to achieving that goal. This ensures that the activity is structured and purpose-driven, providing a clear roadmap for participant collaboration.

Machine learning further enhances the grouping process by classifying participants based on a variety of factors, including their interests, potential, roles, and preferences. This classification enables the creation of diverse and balanced groups that foster dynamic interactions and effective teamwork. By analyzing these inputs, the system can identify complementary skill sets and perspectives, promoting an inclusive and collaborative environment. Additionally, this approach allows for adaptive adjustments, ensuring that group compositions align with both the activity's objectives and the participants' unique attributes.

The combination of goal-oriented task generation and personalized group assignments transforms breakout room activities into meaningful and engaging learning experiences. It optimizes group dynamics, supports individual growth, and ensures that each participant contributes to and benefits from the activity. This application of machine learning exemplifies how technology can enhance classification and organization methods, making group-based activities more efficient, equitable, and impactful.

Using MLMs to assign participants to breakout rooms for collaborative activities offers several key benefits that enhance the effectiveness and efficiency of group-based learning. One significant advantage is the ability to personalize group assignments by analyzing diverse factors such as student interests, potential, roles, and preferences. This leads to the formation of balanced and diverse groups where participants' complementary skills and perspectives enhance collaboration and problem-solving. MLMs also ensure that group assignments align with ensuring that each breakout room has participants able to manage specific activity goals, which are supported by dynamically generated task lists tailored to the objectives. This structured approach not only promotes a focused and productive learning environment but also ensures that all participants have clear roles and contributions, fostering engagement and accountability.

Moreover, the scalability of ML systems allows presenters or educators to manage large numbers of participants efficiently, automating a complex process that would otherwise be time-consuming and prone to bias. These MLMs provide data-driven decisions, reducing subjective influences and ensuring fairness in group formation. Additionally, ML enables continuous refinement of group assignments by learning from past activities, improving the quality of future collaborations. This adaptive capability makes it possible to address diverse educational needs, creating equitable opportunities for students to participate meaningfully. By leveraging these technological benefits, educators can transform traditional breakout room activities into optimized, impactful learning experiences that support both individual and collective growth.

Accordingly, the present disclosure utilizes MLMs to identify and organize participants into breakout rooms for completing a shared activity. One aspect involves obtaining a list of goals for a shared group activity. A second aspect involves classifying participants into different roles based on classification criterions, participant preferences and backgrounds, and the list of goals using a prepared classification MLM. A third aspect involves generating tasks for the shared activity to determine tasks involved in the shared activity based on the list of goals using a task generation MLM. A fourth aspect involves assigning the plurality of participants into groups based on the classification and generated tasks. Turning now to the figures, example aspects are depicted with reference to one or more components described herein, where components in dashed lines may be optional.

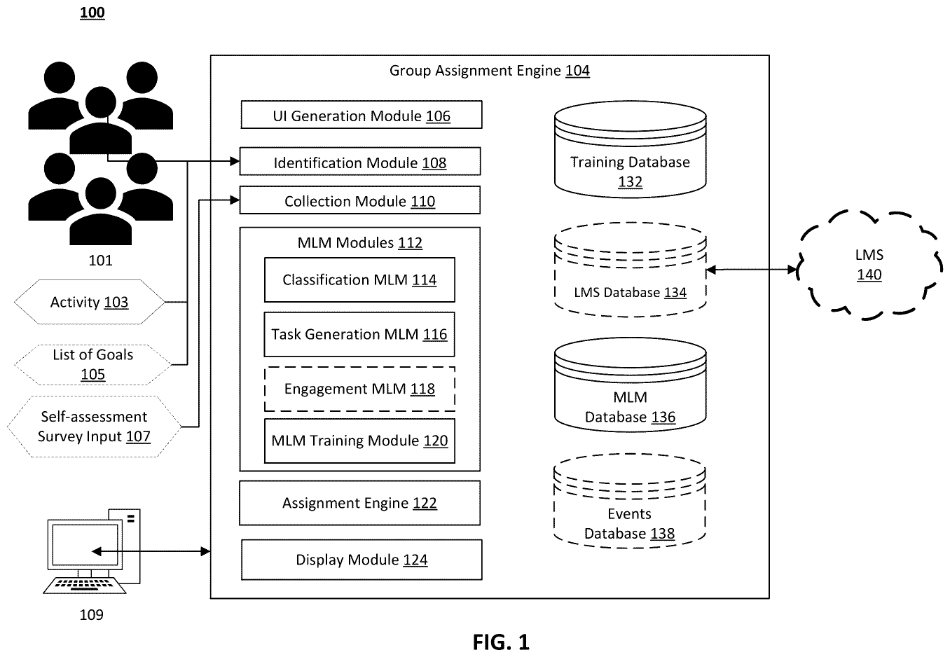

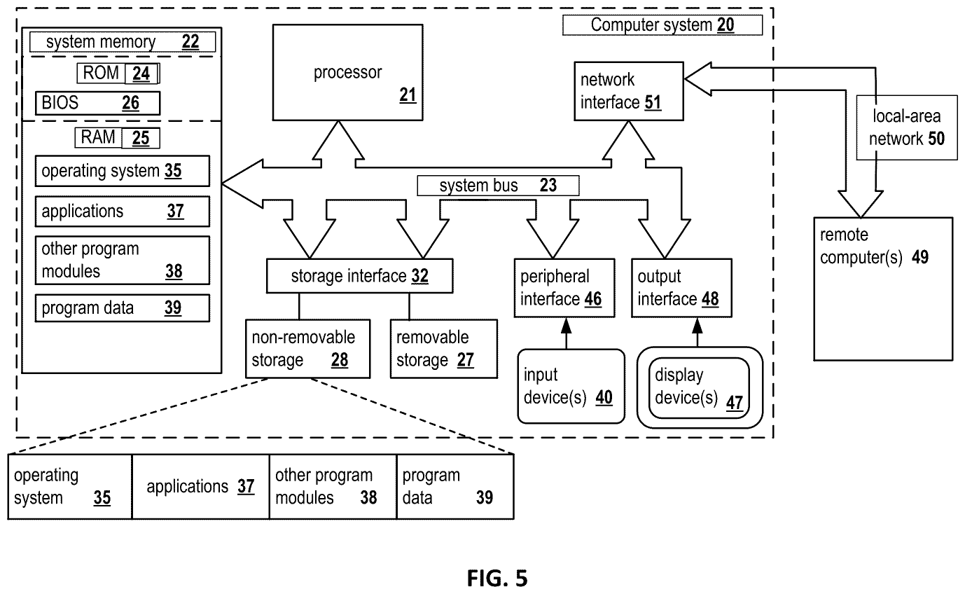

FIG. 1 is a block diagram illustrating a system 100 configured to assign participants into a plurality of groups based on a classification of the participants. In one aspect, the components of system 100 may be implemented on computer systems, such as that shown in FIG. 5.

The system 100 may be used to identify, classify, and group participants into breakout rooms for completing a group activity or assignment. The group assignment engine 104 is configured to identify participants 101 and classify the participants 101 based on participant attributes such as interests, goals, careers, preferences, learning styles, or the like. In addition, the group assignment engine 104 is also configured to obtain a list of goals 105 for an activity 103 or a type of shared activity. Furthermore, the group assignment engine 104 is configured to generate predicted tasks needed for the activity 103 or type of activity. Finally, the group assignment engine 104 will assign the participants 101 into groups based on the classification, predicted tasks, and list of goals.

In this way, the group assignment engine 104 can quickly leverage participant attributes and predicted tasks for a group activity to ensure precise and tailored grouping that eliminates the reliance on manual or random assignment. In addition, by generating predicted tasks for the activity, the group assignment engine 104 provides structure and clarity for enhancing the participants'ability to contribute meaningfully and stay focused. The classification process ensures that groups are diverse and balanced, fostering rich interaction and collaboration among participants with commentary skills and perspectives. In addition, automating the identification, classification, and grouping of participants significantly reduces the time and effort required to organize breakout rooms, especially for large-scale activities. This scalability makes the system suitable for educational, corporate, and other collaborative settings where analyzing and managing large participant pools can be a logistical challenge.

The system 100 includes at least a plurality of participants 101, an activity 103 (or type of activity), a list of goals 105, self-assessment survey input 107, a group assignment engine 104, and an optional learning management system (LMS) 140. The group assignment engine 104 may be configured to organize the plurality of participants 101 into different breakout rooms for completing the activity 103. The computing device 109 may execute a plurality of modules in the group assignment engine 104 that together make up the collection, analysis, prediction, and assignment system. In some aspects, the group assignment engine 104 may correspond to the computing device 109 or cloud network (not shown) that is configured to execute a plurality of modules that together make up the group assignment engine 104 for classifying participants and assigning the participants 101 into breakout groups. It should be noted that only six participants are depicted in FIG. 1, but the present disclosure is not limited to any number of participants and may be applied to any number of participants.

In some aspects, the group assignment engine 104 may include a user interface (UI) generation module 106, an identification module 108, a collection module 110, a MLM module 112 including at least a classification MLM 114, a task generation MLM 116, an optional engagement MLM 118, and a MLM training module 120, an assignment engine 122, a display module 124, a training database 132, an optional LMS database 134, a MLM database 136, and an optional events database 138. In some aspects, training data for the MLM training module 120 may be stored on a training database 132. In some aspects, data from cameras, microphones, and screen captures of the computing devices used by the participants may be stored in the optional events database 138. In some aspects, a prepared classification MLM 114, a prepared task generation MLM 116, and/or an optional prepared engagement MLM 118 may be stored on a MLM database 136. In some aspects, the training database 132, the optional LMS database 134, the MLM database 136, and the optional events database 138 may be stored on a local device or a cloud network.

The computing device 109 may execute a UI generation module 106 to implement a UI for display on the computing device 109 that is configured to receive inputs from the participants 101 or an administrator/facilitator and display a list of goals for the activity 103 and assignment of the participants 101. Accordingly, the computing devices (not shown) for each participant may also display an optional self-assessment survey or respective group assignment from the group assignment engine 104.

In some aspects, the UI generation module 106 generates a single UI for the computing device 109 and layout and components of the UI elements (e.g., menus, buttons, forms, grids, etc.) based on predefined rules, data models, or templates. In some aspects, the UI generation module 106 may also be configured to automatically adjust the UI elements based on the content or data that it needs to display such as adapting a form to input fields or displaying a list of items. In some aspects, the UI generation module 106 may also be configured to adapt the UI to different screen sizes and resolutions by making sure that the UI works well across various devices.

The computing device 109 may execute an identification module 108 that identifies an activity 103 to be performed and a plurality of participants 101 to be classified and organized into groups for breakout rooms. Specifically, the identification module 108 identifies the specific activity and/or type of activity to be performed and the plurality of participants 101 to assign into breakout rooms based on predefined criteria (e.g., skill sets, preferences, or roles). By automating this process, the identification module 108 ensures optimized group composition. This capability is significant as it reduces administrative and computational overhead, enhances participant engagement, and ensures that group dynamics align with the activity's goals, ultimately improving outcomes in both educational and professional settings.

The computing device 109 may execute a collection module 110 that collects and obtains a self-assessment survey input 107, optional data streams from cameras (not pictured) capturing the participants 101, microphones (not pictured) capturing audio from the participants 101, and screen captures of the computing devices (not pictured) of the participants 101 in order to evaluate the engagement of the participants 101 during a presentation that occurs before the breakout rooms.

In some aspects, data for each participant 101 may be obtained from the LMS 140 by the collection module 110. The LMS is a software platform that helps educators manage, deliver, and track educational content and training programs. It acts as a central hub for creating, distributing, and organizing learning materials, assignments, assessments, and communications for both in-person and online learning environments. With an LMS, instructors can create courses, upload content (like readings, videos, or quizzes), and manage assignments, grades, and attendance all in one place. Learners can access their course materials, submit assignments, take quizzes, engage in discussions, and receive feedback directly within the system. LMS platforms are widely used by educational institutions, corporations, and organizations for both formal education and professional training, as they provide a scalable way to deliver personalized learning experiences and track learner progress effectively.

The LMS data may be categorized broadly based on the various functions and interactions that take place within the LMS. The LMS data may include course data that includes information about courses such as course titles, descriptions, syllabus details, instructional content (documents, videos, quizzes), learning modules, and activities. It also includes course duration, structure, and related resources used by learners and instructors. LMS data may include learning progress data that captures learners' progress through their courses. It includes information about course completion rates, progress tracking, assignments submitted, quiz scores, badges earned, and time spent on different sections or lessons. Learning progress data helps instructors assess how well learners are following along and identify areas where additional support might be needed. LMS data may include assessment data comprises all the information related to evaluations, such as quiz and test scores, feedback on assignments, participation in assessments, and grades. It also includes performance trends over time and proficiency scores in specific topics. LMS data may also include engagement data measures how actively learners participate within the LMS environment. This can include metrics such as login frequency, participation in discussion forums, completion of activities, and engagement with course content (e.g., clicks on videos, frequency of accessing reading materials). LMS data may also include behavioral data records learners' interactions with the LMS, such as login timestamps, clicks, navigation behavior, time spent on different resources, and sequences of actions taken. This data helps to understand usage patterns and identify potential roadblocks or opportunities for improving the learning experience.

LMS data may also include feedback data refers to any comments, surveys (e.g., self-assessment survey input 107), or ratings submitted by learners regarding courses or the overall learning experience. It includes instructor feedback provided to learners on assignments or exams as well. LMS data may also include completion data that involves data on course outcomes, such as completed modules, final grades, earned certifications, and dropout rates. Completion data provides insights into learner success and course effectiveness. LMS data may also include attendance data that indicates who attended, how often learners join live lectures or webinars, and any participation rates in live components of the learning. LMS data may also include learning paths and recommendations that reflect personalized paths assigned to different learners, which might include prerequisites completed, courses recommended, suggested resources, and individualized learning plans.

The computing device 109 may execute a MLM module 112 including at least a classification MLM 114, a task generation MLM 116, an optional engagement MLM 118, and a MLM training module 120. The classification MLM 114 analyzes participant data, such as profiles, preferences, or activity-related responses, to categorize them based on attributes like skill levels, expertise, or learning preferences. Simultaneously, the task generation MLM 116 creates or recommends tasks tailored to the activity's objectives and the classifications of the participants 101. These tasks are designed to align with the overarching goals of the activity while promoting meaningful engagement by leveraging the strengths and attributes of the participants 101. By automating the grouping and task allocation process, the system 100 streamlines activity management, allowing facilitators to efficiently scale operations while providing participants 101 with customized and engaging experiences.

The MLMs in the MLM module 112 may correspond to a large language model (LLM). It should be noted that LLMs are described in this present disclosure for illustrative purposes only and that any suitable MLM may be utilized to perform the particular specific tasks of the classification MLM 114, the task generation MLM 116, and the optional engagement MLM 118.

A LLM is an advanced artificial intelligence system designed to understand and generate human-like text. These models are trained on vast amounts of data, enabling them to comprehend context, recognize patterns, and produce coherent and contextually relevant responses. LLMs are utilized in various applications, including chatbots, content creation, and language translation. Their ability to process and generate natural language makes them powerful tools for enhancing communication and automating tasks that require language understanding. However, the LLM modules must first go through preparing (e.g., training, retraining, distillation, fine-tuning, etc.) to teach each LLM model to perform their respective specific tasks. As a nonlimiting example, the LLM models may incorporate one of the machine learning models listed below.

A transformer is a deep learning architecture used in LLMs. The transformer has an encoder/decoder structure with numerous stacked multi-head attention layers and feed forward network layers. This architecture allows the model to process and generate text effectively, capturing long-range dependencies and contextual information. Transformers are well-suited for tasks like natural language processing, and image classification and generation. Common examples of transformer models are generative pre-trained transformer (GPT) and Bidirectional Encoder Representations from Transformers (BERT).

A classification model is a type of machine learning model that is designed to predict the category or class to which a given data point belongs to. The classification model works by analyzing input features and assigning them to one of several predefined labels. These models are trained on labeled data, where the correct category is known, and they learn patterns that allow them to make predictions on new, unseen data. Examples of classification models include at least a regression model used for binary classification, a decision tree used to predict class by splitting data based on feature values, support vector machine (SVM) configured to perform classification by finding the best boundary between classes, and neural networks.

In some examples, a prepared classification MLM 114 may comprise one or more neural networks, which are a class of machine learning models inspired by the structure and functioning of the human brain. They consist of interconnected nodes, called neurons or artificial neurons, organized into layers. Neural networks are capable of learning complex patterns and representations from data. The neural network executed by the presentation evaluation MLM may be one of the following: transformer neural network, convolution neural network (CNN), recurrent neural network (RNN), long short-term memory (LSTM) network, gated recurrent unit (GRU) network, autoencoder, generative adversarial network (GAN).

An autoencoder is a type of neural network used for unsupervised learning and dimensionality reduction and consists of an encoder that compresses input data into a lower-dimensional representation (encoding) and a decoder that reconstructs the original input from the encoding.

For classification and/or analysis tasks such as classifying the participants 101, an untrained classification MLM 114 will first analyze data from a training set to “learn” what the different classifications and how to identify which participants 101 belong in which classifications. As an example, the classification training dataset may include at least: (a) participant-specific data labeled and annotated with at least demographics, skills and expertise, experience, behavioral traits, or historical role data, (b) group activity context data labeled and annotated with at least activity type, goals, or constraints, (c) role data comprising at least role categories or role criteria, (d) interaction and communication data labeled and annotated with collaboration patterns, communication metrics, or team dynamics, (e) ground truth labels for the participant-specific data, the group activity context data, the role data, or the interaction and communication data to serve as a target output for the classification MLM 114, or (f) feedback from a user.

During training of the classification MLM 114, the results from the untrained MLM are then compared with known data set results using the corresponding labels identifying different classifications and different roles. It should be noted that the input to the trained classification MLM 114 will be data from the training dataset.

For every input training sample from the training dataset from the training database 132, the trained classification MLM 114 will produce a prediction consisting of values representing a probability that a particular participant belongs to a class and/or role. The output with the highest probability determines the predicted class. A class label for each classification may be used to compute a loss (e.g., loss function).

The trained classification MLM 114 then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal. In some examples, an appropriate loss function, such as Mean Squared Error (MSE) for regression tasks or a Cross-Entropy Loss for classification tasks.

Once the MLM is trained (e.g., inference), the trained classification MLM 114 may generate the different classifications and roles and predict a classification and role for each participant.

During inference, the trained classification MLM 114 does not re-evaluate or adjust the layers of the neural network based on the results. Instead, the inference applies knowledge from the trained neural network and uses it to infer a result. Accordingly, when a new unknown dataset (e.g., new participants and/or activity) is input through the prepared MLM in the trained classification MLM 114, the trained MLM outputs a classification for each participant based on predictive accuracy of the MLM.

Similarly, during preparation (e.g., training) of the task generation MLM in the task generation MLM 116, the task generation training dataset will include at least: (a) activity goal data labeled and annotated with goal descriptions or goal attributes, (b) task data labeled and annotated with task descriptions, task attributes, task roles, or outcome metrics, (c) participation data labeled and annotated with attributes, availability, past task performance, or role history, or (d) ground truth labels for the activity goal data, the task data, or the participation data to serve as a target output for the classification MLM. As a non-limiting example, some examples of predicted tasks for a shared group activity may include brainstorming session, problem solving activities, project planning, role-playing scenarios, learning exercises, collaborative document creation, or feedback rounds.

For every input training sample from the training dataset, the trained task generation MLM 116 will produce a prediction consisting of values representing a probability corresponding to a predicted task for a similar type of activity corresponding to the activity 103. The output with the highest probability determines the predicted tasks for the activity 103.

Similar to the trained classification MLM 114, the trained task generation MLM 116 then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal.

During inference, the trained task generation MLM 116 does not re-evaluate or adjust the layers of the MLM based on the results. Instead, the inference applies knowledge from the trained MLM and uses it to generate a predicted task. Accordingly, when a new unknown dataset (e.g., new activity) is input through the trained task generation MLM 116, the trained MLM outputs a prediction of predicted task for the activity 103.

Optionally, during training of the MLM in the optional engagement MLM 118, the engagement training dataset will include: (a) individual video streams of participants labeled and annotated with facial expressions, gaze direction, body posture, or head movement to capture visual engagement cues, (b) corresponding audio streams labeled and annotated with speech activity, tone analysis, interruptions and pauses, or emotion detection to analyze participation through voice contribution and tone of speech, (c) capture streams of the participants comprising at least one of at least keyboard input, mouse movements, or screen interactions, wherein the capture streams are labeled and annotated with active engagement, passive behavior, or multitasking to measure interaction of the participants with a respective computing device, (d) an event list comprises at least one of interaction events, participation events, attention-related events, engagement-related events, time-based events, or behavioral and biometric events annotated with engagement levels, activity frequency, or contribution quality to capture session-specific events that indicate participant engagement, and (e) ground truth labels for the individual video streams, the corresponding audio streams, the capture streams, or the event list to serve as a target output for the engagement MLM.

In some aspects, an optimizer such as Adam or SGD may be used to train the MLMs in the classification MLM 114, the task generation MLM 116, and the optional engagement MLM 118. In some aspects, the data may be split into training, validation, and test sets. In these aspects, the classification MLM 114, the task generation MLM 116, and the optional engagement MLM 118 are trained on the training dataset and then validated by the validation sets to tune hyperparameters.

The computing device 109 may execute an assignment engine 122 to assign participants 101 into groups for the breakout rooms based at least in part on the output of the classification MLM, the output of the task generation MLM, and the activity 103. Specifically, the assignment engine 122 processes these outputs to form groups with balanced compositions tailored to optimize collaboration, enhance diversity, or meet specific objectives based on the requirements of the activity 103. This system automates the process of group formation and task allocation, enabling facilitators to scale activities efficiently while delivering personalized and productive experiences for participants. By integrating advanced AI models, the approach enhances group synergy, maximizes engagement, and ensures tasks and group dynamics are aligned with the goals of the activity.

In some aspects, the assignment engine 122 may operate through a technical pipeline that integrates machine learning models and optimization algorithms to dynamically assign participants into groups. It begins by collecting and preprocessing input data, including participant profiles, preferences, skills, and the goals or constraints of the activity. In some aspects, the group assignment engine 104 may obtain LMS data from the optional LMS database 134 or the LMS 140. A prepared classification MLM 114 then processes participant data to identify relevant attributes, such as expertise levels, learning styles, or collaboration preferences, by extracting features and assigning categories or generating embeddings for nuanced analysis. Simultaneously, a prepared task generation MLM 116 analyzes the activity's objectives and participant classifications to generate or select tasks tailored to the session. Using these outputs, the assignment engine 122 may employ a grouping algorithm, which may combine rule-based logic and optimization techniques like k-means clustering or graph partitioning to create balanced, effective group compositions. Fairness measures and constraints ensure equitable distribution of participants 101 and adherence to activity requirements, such as group size or skill diversity. The assignment engine 122 then refines group assignments through feedback loops and validation checks, finalizing group configurations and task instructions. These outputs are seamlessly integrated into the group assignment engine 104, automating the creation of breakout rooms and providing participants with tailored tasks. By leveraging advanced NLP models, optimization algorithms, and cloud-based scalability, the group assignment engine 104 efficiently delivers personalized, well-structured group assignments aligned with the activity's goals.

The computing device 109 may execute a display module 124. The display module 124 may be configured to generate and display the group assignments on the computing device 109 and/or the participants' respective computing devices. Generally, the display module 124 is responsible for managing and rendering the visual components of the user interface by handling the presentation of information to the user, ensuring that data and controls are displayed correctly and consistently across the UI.

In some aspects, the display module 124 is configured to render or draw all the elements of the UI, such as windows, buttons, text fields, menus, icons, images, and other components. In some aspects, the display module 124 is configured out update the UI when the data changes or user interactions occur (e.g., clicking a button or typing in a text box) such that the display module updates the UI accordingly. This could mean refreshing a portion of the screen, changing the state of a button, or displaying new data. In other words, the display module 124 may be considered the “view” part of a model-view-controller (MVC) or similar design pattern. It serves as the layer that presents data to the user and receives input to and from the computing device 109.

It should be noted that the analysis, classification, and grouping of the participants 101 and the prediction of the tasks for the activity 103 described in the present disclosure are heavily simplified. One skilled in the art will appreciate that the MLMs utilized may have significantly large datasets with highly specific details. For example, features indicating personal engagement of the participants 101 may include at least one of time in front of camera, speaking time, sharing time, reactions, raising their hand, messaging in the chat, focus on the presentation, switching between browser tabs, etc. This type of analysis would be beyond the capabilities of the human mind because the amount of data to be identified, considered, and processed when classifying participants and predicting tasks for the activity cannot be performed in the human mind or on pen and paper. It should also be noted that although the present disclosure is described in terms of presentations are for illustrative purposes only, the methods and systems described in the present disclosure can be applied to any type of presentation or breakout room activity such as a lecture, sales pitch, business meeting, speeches, storytelling, business strategy meetings, funding proposals, team meetings, workshops, stand-up comedy acts, event hosting and the like.

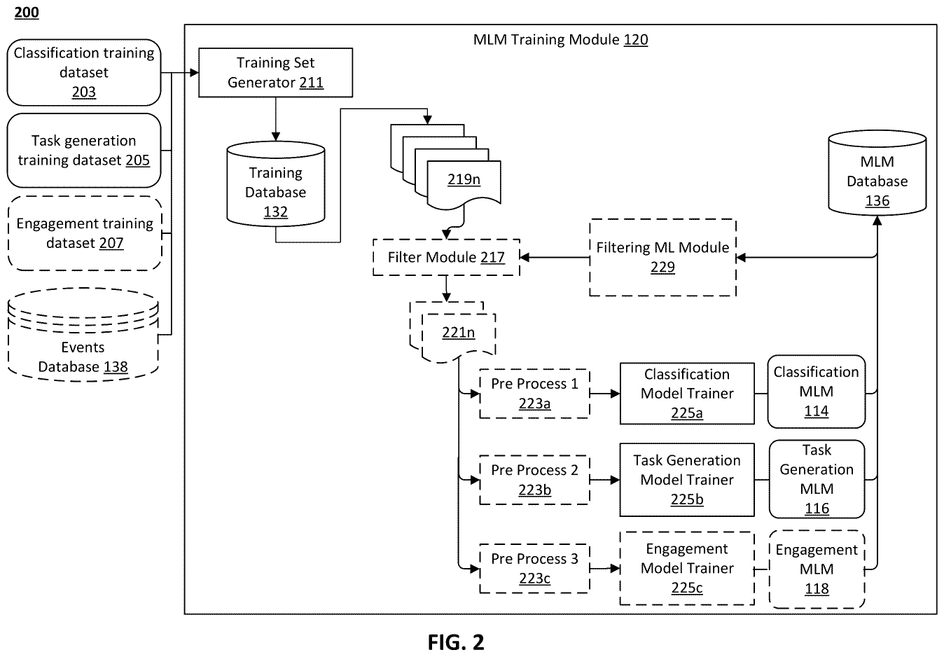

FIG. 2 is a block diagram illustrating a system for preparing machine learning models to classify and organize participants into groups to perform a shared activity and generate tasks for the shared activity according to aspects of the present disclosure. As shown in example 200, the MLM training module 120 is configured to build and train specialized machine learning models with inference to perform particular tasks. This enables the specialized machine learning models to develop an ability to perform particular objectives on inputs that are not part of a training dataset. By subjecting the specialized machine learning models to large amounts of unlabeled and/or labeled training data sets, the specialized machine learning models may perform particular tasks such as evaluating a presentation by generating a presentation score, evaluating an engagement of the audience members by generating an engagement score, and/or identifying a subject matter for the presentation.

Supervised learning is effective for tasks such as classification (assigning inputs to predefined categories) and regression (predicting continuous values) since it relies on the availability of labeled data for both training and evaluation phases. In supervised learning, the MLM training module 120 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, the MLM training module 120 provides the algorithm with a training dataset including input-output pairs. The algorithm learns the mapping function that relates inputs to outputs through an iterative process, adjusting its internal parameters based on the provided examples.

During model building, the algorithm creates a model that can generalize from the training data to make predictions on new, unseen data. The model's complexity varies based on the algorithm used. For example, the model may be a simple linear regression model or a complex neural network. During the prediction phase, the MLM training module 120 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

In some aspects, the MLM training module 120 includes at least a training database 132 configured to store the raw training data 219n and corresponding labels, a MLM database 136 to store the trained models (e.g., the prepared classification MLM 114, the prepared task generation MLM 116, and the optional engagement MLM 118). In some aspects, the MLM training module 120 may include an optional filtering ML module 229 and an optional filter module 217 configured to filter data from the training database 132 for training by removing poorly generated training data.

Training data from a classification training dataset 203, a task generation training dataset 205, an optional engagement training dataset 207, and optional events from the event database 138 is received into the MLM training module 120 via the training set generator 211. Details about the data included in each training dataset is described in more detail above with FIG. 1.

An optional filtering ML module 229 is configured to filter out bad training images and/or data in order to clean up the training data in the training dataset 219n. In some examples, the optional filter module 217 may be a neural network. In some examples, the optional filter module 217 is a mathematical model. In some examples, the cleaned training dataset 221n then undergoes optional preprocessing steps depending on which neural network or model is being trained.

The optional preprocess 1 223a, preprocess 2 223b, and preprocess 3 223 c are automated processes that modify the raw data received from 219n (or cleaned training dataset 221n) and prepare the raw data as input to the respective model trainers (e.g., classification model trainer 225a, task generation model trainer 225b, and optional engagement model trainer 225c). These may be described in the MLM training module 120 as snippets of code that prepares the datasets. In some examples, the preprocessing module (e.g., preprocess 1 223a, preprocess 2 223b, and preprocess 3 223c) for a particular trainer may be an automated script or code that will be setup the first time any model is trained.

The classification model trainer 225a, the task generation model trainer 225b, and the optional engagement model trainer 225c are the scripts or code that train the respective models. The classification model trainer 225a, the task generation model trainer 225b, and the optional engagement model trainer 225c may be a script or code that holds the instructions on how a model should be trained (e.g., optimization method, model architecture, dataset division, etc.) and also runs the training. The classification model trainer 225a, the task generation model trainer 225b, and the optional engagement model trainer 225c each take as input the raw or filtered processed training data and train the classification model trainer 225a, the task generation model trainer 225b, and the optional engagement model trainer 225c to achieve their specific objectives, respectively.

In summary, the raw dataset 219n or cleaned dataset 221n may optionally go through different preprocessing steps 223a, 223b, 223c and then a corresponding classification model trainer 225a, task generation model trainer 225b, or optional engagement model trainer 225c to generate a prepared classification MLM 114, a prepared task generation MLM 116, or an optional prepared engagement MLM 118. In some examples, each of these models may be a MLM or a neural network.

As a non-limiting example and as discussed above, the machine learning may be a neural network. The neural network models are designed using a set of hyperparameters that define high-level aspects of their architecture and training process. These hyperparameters include but are not limited to a combination of architecture type, number of layers, memory size, number of attention heads, learning rate, batch size, optimization algorithm, and the like. Based on these hyperparameters, learnable variables called parameters are initialized, which define the mathematical function that the neural network represents.

The raw training dataset 219n used for training may include noise and bad training images from the training database 132. Accordingly, to create a clean and filtered training dataset, the optional filter module 217 is configured to filter out unwanted data points from the raw training dataset 219n by developing smaller, less accurate systems based on patterns and metadata information.

During the training process, the classification model trainer 225a, the task generation model trainer 225b, and the optional engagement model trainer 225c are presented with input data and labels of actual values, and the optimization objective, which aims to minimize the difference between the actual value and the predicted value, is calculated. The optimization algorithm updates the parameters of the classification model trainer 225a, the task generation model trainer 225b, and the optional engagement model trainer 225c to reduce the value of the objective. This process is repeated for several iterations until the parameters do not change anymore. This process is repeated for various combinations of hyperparameters, and the model with the smallest label prediction error is selected as the final model.

When a new model (e.g., the prepared classification MLM 114, the prepared task generation MLM 116, and the optional engagement MLM 118) is created, and a new process for filtering and automated labeling is established, it is added to the MLM database 136 in the MLM training module 120. This enables the new model to be part of the closed-loop model update process. Optionally, at regular intervals, data which is continuously collected can be filtered, labeled, and used to update old models by an optional filtering ML module 229. In some examples, the optional filtering ML module 229 is a neural network. In some examples, the optional filtering ML module 229 is a mathematical model. This approach may capture changes in the data over time.

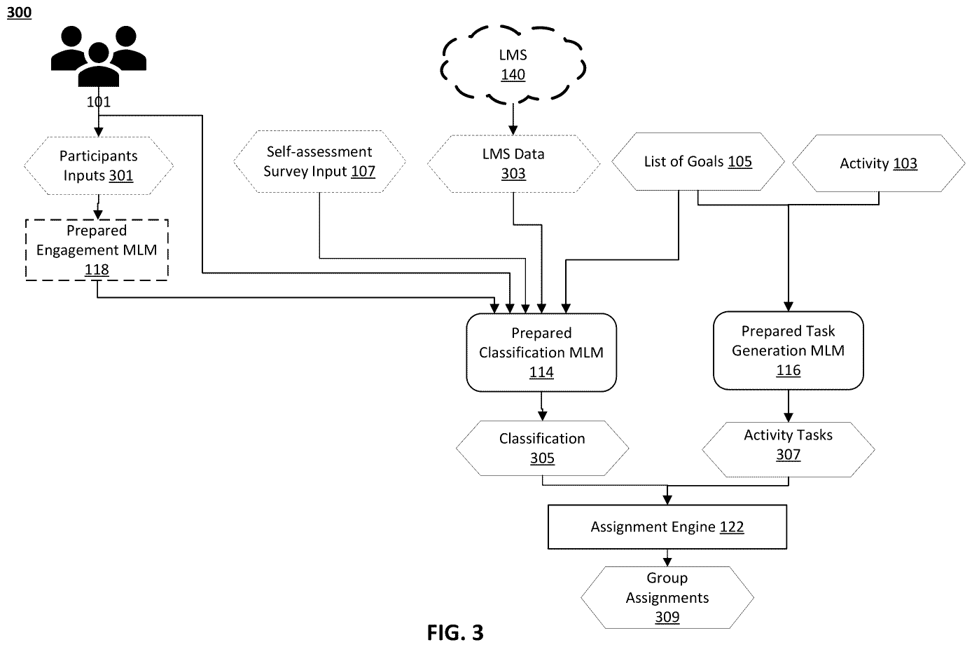

FIG. 3 is an example flowchart for organizing participants into groups according to aspects of the present disclosure. In various implementations, the method 300 is performed by a device with one or more processors and non-transitory memory that performs intent prediction. In some implementations, the method 300 is performed by processing logic, including hardware, firmware, software, or a combination thereof. In some implementations, the method 300 is performed by a processor executing code stored in a non-transitory computer-readable medium (e.g., a memory). The method 300 describes a method of organizing participants into groups based on different classifications according to aspects of the present disclosure.

The method 300 begins by identifying participants 101 to be organized into groups (e.g., breakout rooms) for performing an activity 103. This process may utilize different criteria such as participant roles, skills, preferences, or goals to form optimally balanced groups. By tailoring group composition, the method 300 fosters more effective collaboration, ensuring that each participant contributes meaningfully to the activity. This structured approach enhances the quality of interaction, streamlines task execution, and maximizes the potential for productive outcomes, making it particularly valuable in educational, professional, and team-building contexts.

The prepared classification MLM 114 may classify the participants 101 into specific roles by applying a classification criterion aligned with a predefined list of goals 105 for the activity 103. This role assignment ensures that each participant's skills, expertise, or attributes are matched to the needs of the activity 103, creating a structured and goal-oriented dynamic. By aligning participant roles with activity objectives, this method 300 optimizes team functionality, enhances individual contributions, and improves the overall effectiveness of the group effort. Such a targeted approach is critical in scenarios requiring precision and collaboration, such as project management, education, and collaborative problem-solving.

In some aspects, the prepared classification MLM 114 may also obtain LMS data 303 for the participants 101. As a non-limiting example, the LMS data 303 may include at least one of an overall performance for the participant, interests, parallel courses, career track, learning preference, social circle, or skill. In this way, the prepared classification MLM 114 may further classify and group the participants 101 into different roles involved in the activity 103 by using LMS data 303. By integrating LMS data 303, the prepared classification MLM 114 can make more informed and nuanced classifications, ensuring that roles and groups are aligned with participants' strengths and preferences.

In some aspects, the prepared classification MLM 114 may also obtain data corresponding to participant inputs 301 via a prepared engagement MLM 118 during a presentation or lecture to determine an engagement level of participants. Measuring participants' engagement and focus before classifying and grouping them by the prepared engagement MLM 118 provides critical insights into their current readiness and attention levels. As a non-limiting example, the participant inputs 301 may include video streams capturing each participant during a presentation, audio streams of each participant, and capture streams capturing an interaction of participants during the presentation. Specifically, the method 300 may evaluate an engagement of the participants 101 during the presentation or lecture using a prepared engagement MLM 118 to generate individual engagement scores for the participants 101 based on the participant inputs 301 during the presentation or lecture.

In some aspects, participants 101 may provide self-assessment survey inputs 107 to provide insights into their skills, preferences, confidence levels, and learning goals. The self-reported data allows for more personalized and intentional group formation, ensuring that group roles and dynamics align with individual strengths and areas for growth. In addition, the survey promotes self-reflection, helping participants 101 identify their own capabilities and readiness for the activity 103.

In this way, the prepared classification MLM 114 may incorporate more optional data points such as self-assessment survey inputs 107, engagement scores generated by the prepared engagement MLM 118 based on participant inputs 301, and/or LMS data 303 when classifying and grouping participants. Incorporating additional data points such as self-assessment survey inputs 107, engagement scores generated by the prepared engagement MLM 118 based on participant inputs 301, and LMS data 303 into the prepared classification MLM 114 enhances the precision and adaptability of participant classification and grouping. This comprehensive approach ensures that group formation accounts for a broad spectrum of factors, including participants' self-identified strengths and preferences, real-time engagement levels, and historical performance data. By leveraging these diverse inputs, the method 300 creates groups that are not only balanced and cohesive but also tailored to the specific needs and objectives of the activity. This results in improved collaboration, maximized individual contributions, and a more effective and personalized experience for all participants, making it particularly valuable in dynamic educational and professional settings.

The prepared task generation MLM 116 is configured to generate activity tasks 307 from the list of goals 105 and the activity 103. By analyzing the specific objectives and the context of the activity 103, the prepared task generation MLM 116 predicts activity tasks 307 that align with the intended outcomes of the activity 103, breaking down complex objectives into manageable and actionable tasks. The significance of this method lies in its ability to streamline task creation, enhance clarity, and promote efficiency, resulting in a more focused and effective execution of the activity.

As an example, if the participants 101 are assigned to breakout rooms for an activity 103 of presenting a defense argument in a mock trial court case, then the list of goals 105 may include understanding case details, developing a strong legal strategy, identify and utilize evidence, prepare and present witness testimonies, anticipate prosecution arguments, and craft persuasive arguments. In some aspects, determining the list of goals for a type of activity may involve using a natural language processing (NLP) MLM. The prepared task generation MLM 116 may then determine that the predicted tasks that the participants in the breakout room must complete are case analysis (e.g., assigning one or more participants to analyze the case details including key facts, legal precedents, and evidence relevant to their defense argument), role assignment (e.g., identifying roles such as lead attorney, supporting attorney, and paralegal, ensuring that each participant is matched to a role-based on their skills and strengths), argument constructions (e.g., tasking participants with drafting the main defense argument, counter arguments to anticipate prosecution points, an opening statement, and a closing statement), evidence preparation (e.g., assign team members to organize and present evidence, such as exhibits or witness testimony), mock cross-examination (e.g., assigning participants to prepare and practice cross-examining witnesses or rebutting prosecution claims), and/or presentation coordination/management (e.g., assigning a participant to prepare and practices cross-examining witnesses or rebutting prosecution claims). These tasks ensure a systematic and comprehensive approach to preparing for the mock trial, enabling the group to operate efficiently and collaboratively while maximizing their chances of presenting a compelling defense.

The assignment engine 122 then determines groups assignments 309 for the participants 101 based at least in part on the classification 305 and activity tasks 307. By leveraging the classification 305, which includes information about participants' roles, skills, and attributes, alongside the activity tasks 307 predicted for the activity 103. This dynamic and data-driven approach optimizes group efficiency by aligning participants with tasks and peers that complement their strengths and capabilities. The significance of this method lies in its ability to create well-balanced groups, enhance collaboration, and ensure that tasks are executed effectively, leading to improved outcomes and a more engaging experience for all participants.

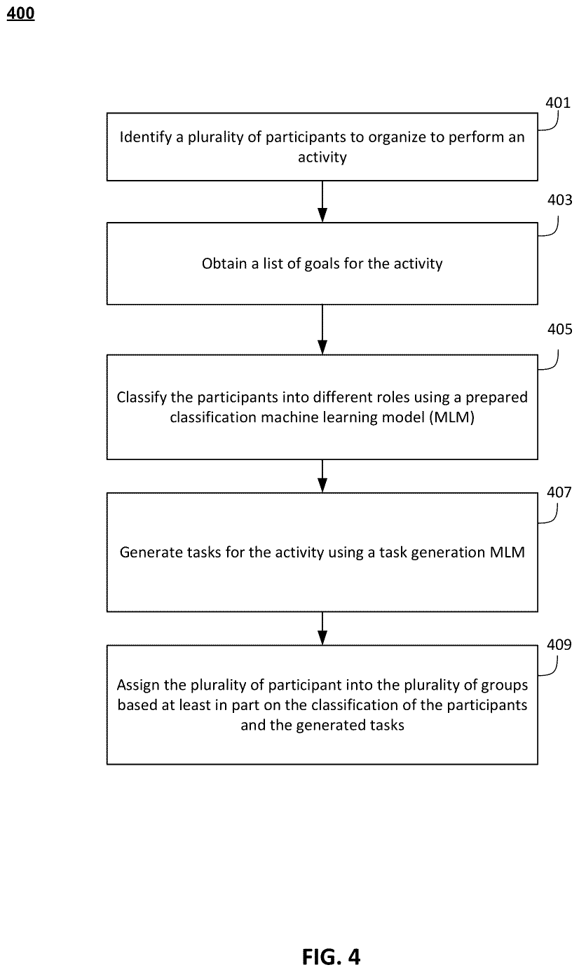

FIG. 4 is an example method for a machine-learning (ML)-based grouping of participants into breakout rooms for completing a shared activity according to an aspect of the present disclosure. In various implementations, the method 400 is performed by a device with one or more processors and non-transitory memory that performs intent prediction. In some implementations, the method 400 is performed by processing logic, including hardware, firmware, software, or a combination thereof. In some implementations, the method 400 is performed by a processor executing code stored in a non-transitory computer-readable medium (e.g., a memory). The method 400 describes a method of grouping participants for an activity according to aspects of the present disclosure.

At 401, the method 400 may include identifying a plurality of participants to perform an activity.

At 403, the method 400 may include obtaining a list of goals for the activity.

In some aspects, the method 400 may include obtaining the list of goals for the activity using a natural language processing (NLP) MLM. This approach leverages the MLM's capability to understand and predict contextually relevant information from input data, enabling the efficient extraction or generation of activity goals. By processing natural language inputs, the NLP MLM can identify key objectives, enhancing the method's ability to align activities with desired outcomes accurately and effectively.

At 405, the method 400 may include classifying the participants into different roles using a prepared classification MLM configured to classify and group the plurality of participants into the different roles involved in the activity based at least in part on a classification criterion and the list of goals for the activity. By leveraging the prepared classification MLM's ability to interpret complex language patterns and contextual information, the method ensures that participants are assigned roles that align with both their capabilities and the activity's objectives.

In some aspects, the method 400 may include: identifying the plurality of participants to organize into groups after a presentation; obtaining, for each participant during the presentation, a plurality of video streams capturing each respective participant, a plurality of audio streams for each respective participant, and a plurality of capture streams capturing an interaction of each participant with a respective computing device; evaluating an engagement of at least one participant during the presentation using a prepared engagement MLM configured to generate an individual engagement score for the at least one participant based on the plurality of video streams, the plurality of audio streams, and the plurality of capture streams; and classifying the participants into different roles using the prepared classification MLM configured to classify and group the plurality of participants into the different roles involved in the activity based at least in part on the classification criterion, the list of goals for the activity, and individual engagement scores. Using this data, a prepared engagement MLM evaluates each participant's engagement by analyzing visual cues from the video streams, vocal attributes from the audio streams, and interaction patterns from the capture streams to generate an individual engagement score. These scores, combined with the classification criteria and the list of activity goals, are then processed by a classification MLM to assign participants to different roles within the activity.

In some aspects, the method 400 may include obtaining learning management system data (LMS) data for at least one participant, wherein the LMS data corresponds to at least one of an overall performance for participants, interests, parallel courses, career track, learning preference, social circle, or skill; and classifying the participants into different roles using the prepared classification MLM configured to classify and group the plurality of participants into the different roles involved in the activity based at least in part on the classification criterion, the list of goals for the activity, and the LMS data. The LMS data provides valuable insights into each participant's academic background, personal interest, and learning behaviors. The prepared classification MLM may utilize the LMS data, alongside the classification criteria and the list of goals of the activity, to accurately classify and group participants into roles that align with their strengths and development needs. By integrating LMS data into the role assignment process, the method enhances personalized learning experiences, fosters more effective collaboration, and ensures that participants are positioned to contribute meaningfully to the activity based on their unique profiles.

At 407, the method 400 may include generating tasks for the activity using a task generation MLM configured to determine tasks for the participants involved in the activity based on the list of goals for the activity. This task generation MLM is designed to analyze the list of goals for the activity and determine specific, goal-aligned tasks for the participants involved. By leveraging its natural language processing capabilities, the task generation MLM can create tasks that are contextually relevant and tailored to support the achievement of the activity's objectives. The significance of this approach lies in its ability to automate task creation with precision, ensuring that each participant receives tasks that contribute meaningfully to the overall goals, promote efficient workflow, and enhance the effectiveness of the activity.

At 409, the method 400 may include assigning, using an assignment engine, the plurality of participant into a plurality of groups based at least in part on the classification of the participants and the generated tasks. This engine operates based on the prior classification of participants, which considers factors such as roles, engagement levels, and optional LMS data, as well as the tasks generated for the activity. By analyzing these inputs, the assignment engine strategically groups participants to optimize team dynamics, ensuring that each group has a balanced distribution of skills, roles, and task alignment.

In some aspects, the method may include obtaining answer from a self-assessment survey for each participant; and classifying the participants into different roles using the prepared classification MLM configured to classify and group the plurality of participants into the different roles involved in the activity based at least in part on the classification criterion, the list of goals for the activity, and the answer from the self-assessment survey. The survey may capture valuable self-reported data on participants'skills, preferences, strengths, and areas for improvements. The prepared classification masked language model (MLM) then utilizes these self-assessment responses, alongside the classification criteria and the list of activity goals, to classify and group participants into appropriate roles.

As a non-limiting example, the self-assessment jersey may contain questions pertaining to a desired role (e.g., leader, follower, listener, speaker), interests (e.g., business, science, art, philosophy, literature), skills (e.g., management, math, writing, poetry, acting), self-estimation of potential engagement (e.g., energy level), social circle/friends, and/or learning preferences (e.g., visual learner, etc.). In this way, learners may be classified in groups based on various criteria (e.g., active, passive, interests, energy level). For example, “active” students may be grouped with other “active” students. As another example, a group may have a diverse mix of “active” students and “non-active” students.

In some aspects, the method 400 may include obtaining feedback corresponding to the grouping of the participants into the different roles; and training the prepared classification MLM based on the obtained feedback. This feedback can encompass insights on group dynamics, role effectiveness, and overall activity outcomes, providing valuable data on the success of the initial classifications. By incorporating this feedback into the training process, the classification MLM continuously refines its algorithms, improving its accuracy and adaptability over time. In this way, a feedback-driven, self-improving system may be implemented to enhance future participant classifications, leading to more effective team structures, optimized role assignments, and better alignment with activity goals.

In some aspects, the method 400 may include preparing the classification MLM by: (1) providing, to the classification MLM, a classification training dataset comprising at least one of: (a) participant-specific data labeled and annotated with at least demographics, skills and expertise, experience, behavioral traits, or historical role data, (b) group activity context data labeled and annotated with at least activity type, goals, or constraints, (c) role data comprising at least role categories or role criteria, (d) interaction and communication data labeled and annotated with collaboration patterns, communication metrics, or team dynamics, (e) ground truth labels for the participant-specific data, the group activity context data, the role data, or the interaction and communication data to serve as a target output for the classification MLM, or (f) feedback from a user, and (2) preparing the classification MLM using the provided classification training dataset. Once this labeled and annotated training dataset is provided, the classification MLM is trained to recognize patterns and relationships within the data, enabling it to accurately classify and group participants into roles based on relevant attributes. This robust preparation process ensures that the MLM is well-equipped to make informed, context-aware role assignments, ultimately improving the effectiveness of team formations and activity outcomes.

In some aspects, the method 400 may include preparing the task generation MLM by: (1) providing, to the task generation MLM, a task generation training dataset comprising at least one of: (a) activity goal data labeled and annotated with goal descriptions or goal attributes, (b) task data labeled and annotated with task descriptions, task attributes, task roles, or outcome metrics, (c) participation data labeled and annotated with attributes, availability, past task performance, or role history, or (d) ground truth labels for the activity goal data, the task data, or the participation data to serve as a target output for the classification MLM; and (2) preparing the task generation MLM using the provided task generation training dataset.

In some aspects, the method 400 may include preparing the engagement MLM by: (1) providing, to the engagement MLM, an engagement training dataset comprising at least one of: (a) individual video streams of participants labeled and annotated with facial expressions, gaze direction, body posture, or head movement to capture visual engagement cues, (b) corresponding audio streams labeled and annotated with speech activity, tone analysis, interruptions and pauses, or emotion detection to analyze participation through voice contribution and tone of speech, (c) capture streams of the participants comprising at least one of at least keyboard input, mouse movements, or screen interactions, wherein the capture streams are labeled and annotated with active engagement, passive behavior, or multitasking to measure interaction of the participants with a respective computing device, (d) an event list comprises at least one of interaction events, participation events, attention-related events, engagement-related events, time-based events, or behavioral and biometric events annotated with engagement levels, activity frequency, or contribution quality to capture session-specific events that indicate participant engagement, and (e) ground truth labels for the individual video streams, the corresponding audio streams, the capture streams, or the event list to serve as a target output for the engagement MLM; and (2) preparing the engagement MLM using the provided engagement training dataset.

In some aspects, the method 400 may include generating and displaying, on a display, a list of group assignments for the plurality of participants. This process involves compiling the results from the classification and assignment steps, where participants have been grouped based on factors such as roles, engagement levels, skills, and activity goals. The generated list provides a clear, organized overview of each participant's assigned group and role, which can be easily viewed and referenced by both participants and facilitators.

In some aspects, the method 400 may include assigning the plurality of participants to virtual breakout rooms. This step involves automatically distributing participants into designated virtual spaces based on their group assignments, roles, and activity objectives. By leveraging the prior classification and grouping data, the method ensures that each breakout room is optimized for collaboration, with participants strategically placed to maximize engagement and productivity. The significance of this process lies in its ability to streamline virtual interactions, foster focused group discussions, and enhance the efficiency of remote or hybrid activities by reducing the time and effort required for manual group organization.

FIG. 5 presents an example of a general-purpose computer system on which aspects of the present disclosure can be implemented.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-4 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for machine-learning (ML)-based grouping of participants for an activity, comprising:
identifying a plurality of participants to perform an activity;
obtaining a list of goals for the activity;
classifying the participants into different roles using a prepared classification machine learning model (MLM) configured to classify and group the plurality of participants into the different roles involved in the activity based at least in part on a classification criterion and the list of goals for the activity;
generating tasks for the activity using a task generation MLM configured to determine tasks for the participants involved in the activity based on the list of goals for the activity; and
assigning, using an assignment engine, the plurality of participant into a plurality of groups based at least in part on the classification of the participants and the generated tasks.

2. The method of claim 1, further comprising:
identifying the plurality of participants to organize into groups after a presentation;
obtaining, for each participant during the presentation, a plurality of video streams capturing each respective participant, a plurality of audio streams for each respective participant, and a plurality of capture streams capturing an interaction of each participant with a respective computing device;
evaluating an engagement of at least one participant during the presentation using a prepared engagement MLM configured to generate an individual engagement score for the at least one participant based on the plurality of video streams, the plurality of audio streams, and the plurality of capture streams; and
classifying the participants into different roles using the prepared classification MLM configured to classify and group the plurality of participants into the different roles involved in the activity based at least in part on the classification criterion, the list of goals for the activity, and individual engagement scores.

3. The method of claim 1, further comprising:
obtaining learning management system data (LMS) data for at least one participant, wherein the LMS data corresponds to at least one of an overall performance for participants, interests, parallel courses, career track, learning preference, social circle, or skill; and
classifying the participants into different roles using the prepared classification MLM configured to classify and group the plurality of participants into the different roles involved in the activity based at least in part on the classification criterion, the list of goals for the activity, and the LMS data.

4. The method of claim 3, further comprising:
obtaining feedback corresponding to the grouping of the participants into the different roles; and
training the prepared classification MLM based on the obtained feedback.

5. The method of claim 1, further comprising:
obtaining answer from a self-assessment survey for each participant; and
classifying the participants into different roles using the prepared classification MLM configured to classify and group the plurality of participants into the different roles involved in the activity based at least in part on the classification criterion, the list of goals for the activity, and the answer from the self-assessment survey.

6. The method of claim 5, further comprising:
obtaining feedback corresponding to the classification of the participants into the different roles; and
training the prepared classification MLM based on the obtained feedback.

7. The method of claim 1, further comprising:
obtaining the list of goals for the activity using a natural language processing (NLP) MLM.

8. The method of claim 1, further comprising preparing the classification MLM by:
(1) providing, to the classification MLM, a classification training dataset comprising at least one of:
(a) participant-specific data labeled and annotated with at least demographics, skills and expertise, experience, behavioral traits, or historical role data,
(b) group activity context data labeled and annotated with at least activity type, goals, or constraints,
(c) role data comprising at least role categories or role criteria,
(d) interaction and communication data labeled and annotated with collaboration patterns, communication metrics, or team dynamics,
(e) ground truth labels for the participant-specific data, the group activity context data, the role data, or the interaction and communication data to serve as a target output for the classification MLM, or
(f) feedback from a user, and
(2) preparing the classification MLM using the provided classification training dataset.

9. The method of claim 1, further comprising preparing the task generation MLM by:
(1) providing, to the task generation MLM, a task generation training dataset comprising at least one of:
(a) activity goal data labeled and annotated with goal descriptions or goal attributes,
(b) task data labeled and annotated with task descriptions, task attributes, task roles, or outcome metrics,
(c) participation data labeled and annotated with attributes, availability, past task performance, or role history, or
(d) ground truth labels for the activity goal data, the task data, or the participation data to serve as a target output for the classification MLM; and
(2) preparing the task generation MLM using the provided task generation training dataset.

10. The method of claim 2, further comprising preparing the engagement MLM by:
(1) providing, to the engagement MLM, an engagement training dataset comprising at least one of:
(a) individual video streams of participants labeled and annotated with facial expressions, gaze direction, body posture, or head movement to capture visual engagement cues,
(b) corresponding audio streams labeled and annotated with speech activity, tone analysis, interruptions and pauses, or emotion detection to analyze participation through voice contribution and tone of speech,
(c) capture streams of the participants comprising at least one of at least keyboard input, mouse movements, or screen interactions, wherein the capture streams are labeled and annotated with active engagement, passive behavior, or multitasking to measure interaction of the participants with a respective computing device,
(d) an event list comprises at least one of interaction events, participation events, attention-related events, engagement-related events, time-based events, or behavioral and biometric events annotated with engagement levels, activity frequency, or contribution quality to capture session-specific events that indicate participant engagement, and
(e) ground truth labels for the individual video streams, the corresponding audio streams, the capture streams, or the event list to serve as a target output for the engagement MLM; and
(2) preparing the engagement MLM using the provided engagement training dataset.

11. The method of claim 1, further comprising:
generating and displaying, on a display, a list of group assignments for the plurality of participants.

12. The method of claim 1, further comprising:
assigning the plurality of participants to virtual breakout rooms.

13. A system for machine-learning (ML)-based grouping of participants for an activity, comprising:
at least one memory; and
at least one hardware processor coupled with the at least one memory and configured, individually or in combination, to:
identify a plurality of participants to perform an activity;
obtain a list of goals for the activity;
classify the participants into different roles using a prepared classification machine learning model (MLM) configured to classify and group the plurality of participants into the different roles involved in the activity based at least in part on a classification criterion and the list of goals for the activity;
generate tasks for the activity using a task generation MLM configured to determine tasks for the participants involved in the activity based on the list of goals for the activity; and
assign, using an assignment engine, the plurality of participant into a plurality of groups based at least in part on the classification of the participants and the generated tasks.

14. The system of claim 13, wherein the at least one hardware processor is further coupled with the at least one memory and configured, individually or in combination, to:
identify the plurality of participants to organize into groups after a presentation;
obtain, for each participant during the presentation, a plurality of video streams capturing each respective participant, a plurality of audio streams for each respective participant, and a plurality of capture streams capturing an interaction of each participant with a respective computing device;
evaluate an engagement of at least one participant during the presentation using a prepared engagement MLM configured to generate an individual engagement score for the at least one participant based on the plurality of video streams, the plurality of audio streams, and the plurality of capture streams; and
classify the participants into different roles using the prepared classification MLM configured to classify and group the plurality of participants into the different roles involved in the activity based at least in part on the classification criterion, the list of goals for the activity, and the individual engagement scores.

15. The system of claim 13, wherein the at least one hardware processor is further coupled with the at least one memory and configured, individually or in combination, to:
obtain learning management system data (LMS) data for at least one participant, wherein the LMS data corresponds to at least one of an overall performance for the participant, interests, parallel courses, career track, learning preference, social circle, or skill; and
classify the participants into different roles using the prepared classification MLM configured to classify and group the plurality of participants into the different roles involved in the activity based at least in part on the classification criterion, the list of goals for the activity, and the LMS data.

16. The system of claim 15, wherein the at least one hardware processor is further coupled with the at least one memory and configured, individually or in combination, to:
obtain feedback corresponding to the grouping of the participants into the different roles; and
train the prepared classification MLM based on the obtained feedback.

17. The system of claim 13, wherein the at least one hardware processor is further coupled with the at least one memory and configured, individually or in combination, to: prepare the classification MLM by:
(1) providing, to the classification MLM, a classification training dataset comprising at least one of:
(a) participant-specific data labeled and annotated with at least demographics, skills and expertise, experience, behavioral traits, or historical role data,
(b) group activity context data labeled and annotated with at least activity type, goals, or constraints,
(c) role data comprising at least role categories or role criteria,
(d) interaction and communication data labeled and annotated with collaboration patterns, communication metrics, or team dynamics,
(e) ground truth labels for the participant-specific data, the group activity context data, the role data, or the interaction and communication data to serve as a target output for the classification MLM, or
(f) feedback from a user, and
(2) preparing the classification MLM using the provided classification training dataset.

18. The system of claim 13, wherein the at least one hardware processor is further coupled with the at least one memory and configured, individually or in combination, to: prepare the task generation MLM by:
(1) providing, to the task generation MLM, a task generation training dataset comprising at least one of:
(a) activity goal data labeled and annotated with goal descriptions or goal attributes,
(b) task data labeled and annotated with task descriptions, task attributes, task roles, or outcome metrics,
(c) participation data labeled and annotated with attributes, availability, past task performance, or role history, or
(d) ground truth labels for the activity goal data, the task data, or the participation data to serve as a target output for the classification MLM; and
(2) preparing the task generation MLM using the provided task generation training dataset.

19. The system of claim 13, wherein the at least one hardware processor is further coupled with the at least one memory and configured, individually or in combination, to:
generating and displaying, on a display, a list of group assignments for the plurality of participants.

20. A non-transitory computer readable medium storing thereon computer executable instructions for machine-learning (ML)-based grouping of participants for an activity, including instructions for:
identifying a plurality of participants to perform an activity;
obtaining a list of goals for the activity;
classifying the participants into different roles using a prepared classification machine learning model (MLM) configured to classify and group the plurality of participants into the different roles involved in the activity based at least in part on a classification criterion and the list of goals for the activity;
generating tasks for the activity using a task generation MLM configured to determine tasks for the participants involved in the activity based on the list of goals for the activity; and
assigning, using an assignment engine, the plurality of participant into a plurality of groups based at least in part on the classification of the participants and the generated tasks.
